(19) United States
(12) Patent Application Publication
(10) Pub. No.: US 2009/0240733 A1
(43) Pub. Date: Sep. 24, 2009

(54) METHOD FOR DISPLAYING RECEIVER INFORMATION

(75) Inventors: Shih-Cheng Chou, Taipei City (TW); Shih-Wei Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/190,596

(22) Filed: Aug. 13, 2008

(30) Foreign Application Priority Data
Mar. 20, 2008 (TW) 97109906

(51) Int. Cl. G06F 17/00

(52) U.S. Cl. 707/104.1; 707/E17.019

(57) ABSTRACT

A receiver information display method for displaying receiver information when an e-mail is composed is provided. First, a receiver database is provided, wherein the receiver database contains a receiver data and at least one image corresponding to the receiver data. Then, a receiver account data is provided, and the corresponding image is automatically displayed when the receiver account data matches the receiver data. As a result, a user can identify a receiver instantly, and accordingly the possibility of sending e-mails to wrong receivers can be greatly reduced.

### CROSS-REFERENCE TO RELATED APPLICATION

This application claims the priority benefit of Taiwan application serial no. 97109906, filed on Mar. 20, 2008. The entirety of the above-mentioned patent application is hereby incorporated by reference herein and made a part of this specification.

### BACKGROUND OF THE INVENTION

1. Field of the Invention

The present invention generally relates to a method for transmitting an e-mail, in particular, to a method for displaying receiver information before transmitting an e-mail.

2. Description of Related Art

Along with the rapid advancement of the Internet, people rely more and more on network applications. Since the Internet can be accessed anytime and anywhere, e-mails have gradually replaced conventional mails as one of the major communication channels. Not only people use e-mails to communicate with friends and family members, but many companies also set up their own e-mail servers in order to increase the efficiency of communication between their employees.

Before sending an e-mail, a user has to input a correct e-mail address in order to send the e-mail to the mailbox of the receiver correctly. Regarding the format of e-mail address, the characters to the left of the symbol “@” indicate the account of the receiver, and the characters to the right of the symbol “@” indicate the host name of the receiver. Generally speaking, the English name along with the last name of an employee in a corporation is usually used as the account of the receiver. However, if a corporation has a large number of employees, some employees may have the same English name, and if the spellings of the last names of these employees are very similar, confusion may be caused.

Even though a function for checking the correctness of a receiver's name is provided in an existing e-mail application software (for example, the Microsoft Outlook Express), only the correctness of the receiver's e-mail address input by the user can be checked, and the user still cannot identify whether this is the correct receiver. In other words, foregoing name checking mechanism can only determine the correctness of the receiver's account so as to ensure that the user inputs a correct e-mail address, but cannot provide a function for identifying several similar accounts or allow the user to identify the receiver. In this case, e-mails may be sent to wrong receivers, and accordingly many delays and inconveniences may be caused.

### SUMMARY OF THE INVENTION

Accordingly, the present invention is directed to a receiver information display method, wherein after a user inputs a receiver data, related information (for example, an image) of the receiver is automatically and quickly displayed so that the user can identify the receiver.

The present invention is directed to a receiver information display method for displaying receiver information when an e-mail is composed. The method includes following steps. First, a receiver database is provided, and the receiver database contains a receiver data and an image corresponding to the receiver data, wherein the receiver data may be an e-mail address or an alias. Next, a receiver account data is provided, and the corresponding image is displayed if the receiver account data matches the receiver data.

According to an embodiment of the present invention, the step of providing the receiver account data includes receiving a data input by a user and serving the data input by the user as the receiver account data when a specific signal is received. According to an embodiment of the present invention, the specific signal includes a mouse cursor hover signal corresponding to a data input position. According to another embodiment of the present invention, the specific signal is a key input signal corresponding to a specific key.

According to an embodiment of the present invention, the receiver information display method further includes determining the format of the receiver account data through a regular expression after the step of providing the receiver account data.

According to an embodiment of the present invention, the receiver information display method further includes determining whether the receiver account data matches the e-mail address recorded in the receiver database when the receiver account data is in an e-mail address format after the step of determining the format of the receiver account data, wherein if the receiver account data matches the e-mail address recorded in the receiver database, the image corresponding to the e-mail address is displayed.

According to an embodiment of the present invention, the receiver information display method further includes determining whether the receiver account data matches the alias recorded in the receiver database when the receiver account data is in an alias format after the step of determining the format of the receiver account data, wherein if the receiver account data matches the alias recorded in the receiver database, the image corresponding to the alias is displayed.

According to an embodiment of the present invention, the receiver information display method further includes connecting to an e-mail server for storing the receiver database and querying the receiver database according to the receiver account data after the step of providing the receiver account data, wherein the e-mail server may be a local e-mail server or a remote e-mail server.

According to an embodiment of the present invention, the receiver information display method further includes displaying a prompt message when the receiver account data does not match any e-mail address or alias recorded in the receiver database.

According to an embodiment of the present invention, the step of displaying the corresponding image further includes displaying the corresponding receiver name, displaying the corresponding department, or displaying the image within a specific time period.

In the present invention, a receiver database is queried according to a receiver account data input by a user, and when a content matching the receiver account data is found, the corresponding image of a receiver is automatically displayed so that the user can identify the receiver. Thereby, a receiver can be identified instantly and straightforwardly, and accordingly the possibility of sending e-mails to wrong receivers is greatly reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for displaying receiver information according to an embodiment of the present invention.

FIG. 2 is a flowchart illustrating how a receiver database is queried according to an embodiment of the present invention.

FIG. 3 is a flowchart illustrating a method for displaying receiver information according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

If a photo or other related information of a receiver can be automatically displayed when a user is composing an e-mail, the user can instantly identify the receiver and accordingly the possibility of sending the e-mail to a wrong receiver is greatly reduced. Accordingly, the present invention provides a receiver information display method. To make the characteristics and advantages of the present invention more obvious, embodiments of the present invention will be described below with reference to accompanying drawings.

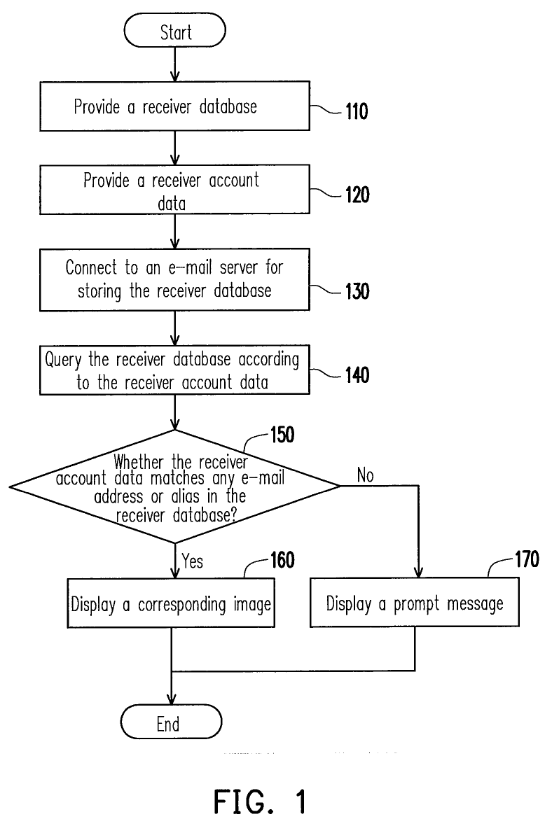

FIG. 1 is a flowchart illustrating a method for displaying receiver information according to an embodiment of the present invention. Referring to FIG. 1, first, in step 110, a receiver database is provided, wherein the receiver database records a receiver data and an image (for example, a photo of a receiver) corresponding to the receiver data. The receiver data contains an e-mail address or an alias. For example, the receiver database of a corporation includes several fields, such as e-mail address, alias, image, receiver name, and department etc, for recording the related information of each employee.

When a user is composing a new e-mail, the user has to fill in the data of the receiver into the receiver field of the e-mail. In step 120, the data input by the user is served as a receiver account data when a specific signal is received. In an embodiment of the present invention, the specific signal may be a mouse cursor hover signal corresponding to the data input position. Namely, when the user moves the mouse cursor to the receiver field of the e-mail, the data pointed by the mouse cursor is served as the receiver account data. In another embodiment of the present invention, the specific signal may be a key input signal corresponding to a specific key (for example, the “;” key, the “Tab” key, or the “Enter” key). Namely, the data input before the specific key is pressed is served as the receiver account data once the user presses the specific key.

Next, the receiver account data and the receiver data in the receiver database are compared. First, in step 130, an e-mail server for storing the receiver database is connected to, so as to check the receiver's identity. In the present embodiment, the e-mail server may be a local e-mail server or a remote e-mail server; however, the scope of the e-mail server is not limited in the present invention.

Thereafter, in step 140, the receiver database is queried according to the receiver account data input by the user, and in step 150, whether the receiver account data matches any e-mail address or any alias recorded in the receiver database is determined. If a content matching the receiver account data is found in the receiver database (i.e. the receiver database contains an e-mail address or an alias matching the receiver account data), then in step 160, an image corresponding to the receiver data is displayed. In another embodiment of the present invention, besides displaying the image within a specific time period, other information, such as the receiver name or department, recorded in the receiver database may be further displayed so that the user can identify the receiver accordingly.

However, if nothing matching the receiver account data can be found in the receiver database, then it is determined that the receiver input by the user is not recorded in the receiver database. Thus, in step 170, a prompt message is displayed to notify the user that the receiver is not recorded in the receiver database. The user can then modify the data in the receiver field according to the actual requirement, so as to complete the composition of the e-mail.

Through the steps illustrated in FIG. 1, the user can instantly identify the receiver by looking at the automatically displayed image of the receiver before sending the e-mail, so that the possibility of sending the e-mail to the wrong receiver is greatly reduced. However, it has to be mentioned herein that the environment for composing the e-mail is not restricted in the present embodiment. In other words, regardless of whether the user executes an e-mail application program and composes a new e-mail in a personal computer (PC), a notebook computer, a personal digital assistant (PDA), or a smart phone, the receiver information can be automatically displayed and accordingly the receiver can be instantly and conveniently identified through the steps described in foregoing embodiment.

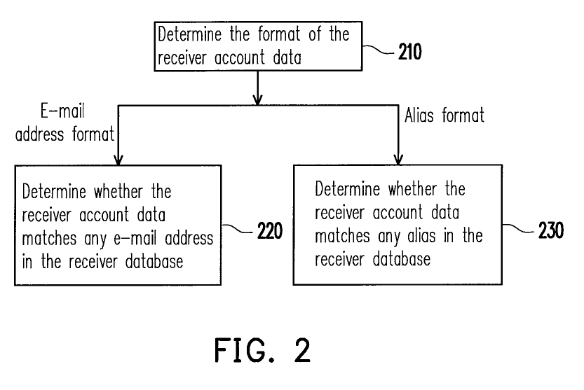

In another embodiment of the present invention, in order to increase the speed of determining whether the receiver account data matches the content of the receiver database, in step 210 (as shown in FIG. 2), the format of the receiver account data is first determined through a regular expression after the receiver database and the receiver account data are provided. Since all e-mail addresses have a fixed format, the receiver account data is determined to have an e-mail address format when it is processed through the regular expression and a symbol “@” is identified. Then, in step 220, all the e-mail addresses recorded in the receiver database are queried to find an e-mail address matching the receiver account data. However, if no “@” symbol is obtained after the receiver account data is processed through the regular expression, the receiver account data input by the user is considered to have an alias format, and in step 230, all the aliases recorded in the receiver database are queried to find an alias matching the receiver account data.

As shown in FIG. 2, the format of the receiver account data is first determined before determining whether the receiver account data matches the content of the receiver database, and different field in the receiver database is queried according to different format of the receiver account data. Finally, whether to display the corresponding image or a prompt message is determined according to whether a matching content is found in the receiver database. Accordingly, it is not needed to query every field in the receiver database so that the speed of querying the receiver account data in the receiver database can be increased and the corresponding receiver information can be displayed more efficiently.

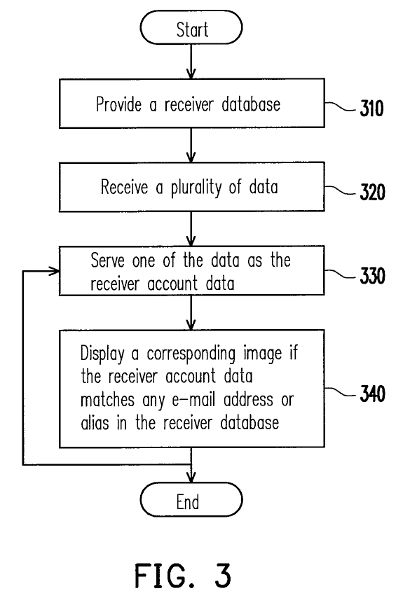

FIG. 3 is a flowchart illustrating a method for displaying receiver information according to another embodiment of the present invention. In the present embodiment, how to display the image or related information corresponding to each receiver when a user inputs a plurality of receivers in the receiver field of the e-mail is described. Referring to FIG. 3, first, in step 310, a receiver database recording the receiver data (for example, e-mail address, alias, receiver name or department) and an image (for example, photo of the receiver) corresponding to the receiver data.

Next, in step 320, a plurality of data input by a user when the user is composing an e-mail is received from the receiver field of the e-mail. In the present embodiment, after the data is input, the user can move the mouse cursor to one of the data to generate a mouse cursor hover signal. Then in step 330, the data pointed by the mouse cursor is considered as the receiver account data. For the convenience of description, here it is assumed that the data input into the receiver field by the user is “aaa@bb.cc;xyz” and the user points the mouse cursor to “aaa@bb.cc” first. Thus, “aaa@bb.cc” is considered the first receiver account data.

Next, in step 340, any content in the receiver database matches the receiver account data (i.e. “aaa@bb.cc”) is determined. If an e-mail address matching “aaa@bb.cc” is found in the receiver database, the corresponding image (for example, a photo of the receiver) is displayed, and the user is allowed to identify that whether this is the correct receiver. However, a prompt message is displayed to notify the user if nothing matching the receiver account data is found in the receiver database.

After the image corresponding to “aaa@bb.cc” is displayed, the procedure returns to step 330 so that the user can move the mouse cursor again and stops at “xyz” to generate a new mouse cursor hover signal. “xyz” is then considered the next receiver account data. After that, in step 340, “xyz” is compared with the content of the receiver database. If an alias matching “xyz” is found in the receiver database, the corresponding image is displayed; otherwise, a prompt message is displayed to notify the user.

As described above, when an e-mail is to be sent to multiple receivers, the user can look at the image or related information of each of the receivers by moving the mouse cursor over the data input by the user, so as to identity all the receivers. It should be mentioned here that in the embodiment described above, the receiver account data is provided by moving the mouse cursor. While in another embodiment of the present invention, when the user presses the “;” key or the “Enter”, the data input before the user presses the key is considered as the receiver account data, and then whether the corresponding image is displayed is also determined by comparing the receiver account data and the content of the receiver database.

In overview, the receiver information display method provided by the present invention has at least following advantages:

1. after a user inputs the receiver account data, a photo or other related information of the receiver is automatically displayed so that the user can identify the receiver instantly.

2. by automatically displaying the related image of the receiver, the user can identify the receiver straightforwardly, so that the possibility of sending the e-mail to a wrong receiver is greatly reduced and the efficiency in communicating through e-mails is increased.

3. when an e-mail is to be sent to multiple receivers, the user can also identify all the receivers through the method provided by the present invention, so that the convenience in sending e-mails is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A receiver information display method, for displaying receiver information when an e-mail is composed, the method comprising:
providing a receiver database, wherein the receiver database contains a receiver data and an image corresponding to the receiver data;
providing a receiver account data;
comparing the receiver data and the receiver account data; and
displaying the corresponding image if the receiver account data matches the receiver data.

2. The method according to claim 1, wherein the step of providing the receiver account data comprises:
receiving a data input by a user; and
serving the data as the receiver account data when a specific signal is received.

3. The method according to claim 2, wherein the specific signal comprises a mouse cursor hover signal corresponding to an input position of the data.

4. The method according to claim 2, wherein the specific signal comprises a key input signal corresponding to a specific key.

5. The method according to claim 1, wherein the receiver data comprises an e-mail address.

6. The method according to claim 5, wherein after the step of providing the receiver account data, the method further comprises:
determining a format of the receiver account data through a regular expression.

7. The method according to claim 6, wherein after the step of determining the format of the receiver account data, the method further comprises:
determining whether the receiver account data matches the e-mail address if the receiver account data is in an e-mail address format; and
displaying the image corresponding to the e-mail address if the receiver account data matches the e-mail address.

8. The method according to claim 1, wherein the receiver data comprises an alias.

9. The method according to claim 8, wherein after the step of determining the format of the receiver account data, the method further comprises:
determining whether the receiver account data matches the alias if the receiver account data is in an alias format; and
displaying the image corresponding to the alias if the receiver account data matches the alias.

10. The method according to claim 1, wherein after the step of providing the receiver account data, the method further comprises:
connecting to an e-mail server for storing the receiver database; and
querying the receiver database according to the receiver account data.

11. The method according to claim 10, wherein the e-mail server comprises a local e-mail server or a remote e-mail server.

12. The method according to claim 1 further comprising:
displaying a prompt message when the receiver account data does not match the receiver data.

13. The method according to claim 1, wherein the step of displaying the corresponding image further comprises displaying a corresponding receiver name.

14. The method according to claim 1, wherein the step of displaying the corresponding image further comprises displaying a corresponding department.

15. The method according to claim 1, wherein the step of displaying the corresponding image further comprises displaying the image within a specific time period.
